(19) United States
(12) Patent Application Publication
(10) Pub. No.: US 2009/0241509 A1
(43) Pub. Date: Oct. 1, 2009

(54) TURBINE ENGINE INLET STRUT DEICING

(76) Inventor: Isaac Jon Hogate, Cromwell, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/054,814

(22) Filed: Mar. 25, 2008

(51) Int. Cl. F02C 7/047

(52) U.S. Cl. 60/39.093; 60/779

(57) ABSTRACT

A gas turbine engine is disclosed that includes an inlet case having circumferentially spaced, radially extending inlet struts. Each inlet strut has a leading and trailing end. Spaced apart sidewalls adjoin the leading and trailing ends. A first heating element is arranged on the leading end. A second heating element is arranged on at least one of the sidewalls. The first heating element is configured to provide a different amount of energy per unit of time than the second heating element.

This invention was made with government support with the United States Navy under Contract No.: N00019-02-C-3003. The government therefore has certain rights in this invention.

### BACKGROUND

This disclosure relates to a deicing system for a gas turbine engine. More particularly, the disclosure relates to a deicing system and method for heating an inlet strut of a gas turbine engine.

Some turbojet engines include a static inlet case that are typically subjected to icing environments. The leading edges of the inlet struts are susceptible to the most ice accretion. Leading edges that are deiced create liquid water on the surface of the strut that can run back along the sidewall of the inlet strut and refreeze. Ice on the sidewall can reach a critical size and shed from the inlet strut into the engine, which can cause damage to the engine parts downstream of the inlet case.

As a result, these turbojet engines typically incorporate some sort of deicing system. For example, engine bleed air may be provided to the inlet strut to deice an inlet component. Heating the entire inlet strut with engine bleed air results in an appreciable loss in power and efficiency from the engine.

What is needed is a deicing system for a turbojet engine inlet case that does not create a loss in performance or efficiency of the engine.

### SUMMARY

A gas turbine engine is disclosed that includes an inlet case having circumferentially spaced, radially extending inlet struts. Each inlet strut has a leading and trailing end. Spaced apart sidewalls adjoin the leading and trailing ends. A first heating element is arranged on the leading end. A second heating element is arranged on at least one of the sidewalls. The first heating element is configured to provide a different amount of energy per unit of time than the second heating element.

These and other features of the disclosure can be best understood from the following specification and drawings, the following of which is a brief description.

### BRIEF DESCRIPTION OF THE DRAWINGS

FIG. 1 is a schematic cross-sectional view of an example turbojet engine.

FIG. 2 is a front elevational view of an inlet case.

FIG. 3 is a cross-sectional view of an inlet strut shown along line 3-3 in FIG. 2.

FIG. 4 is a cross-sectional view of a portion of a sidewall of the inlet strut.

### DETAILED DESCRIPTION

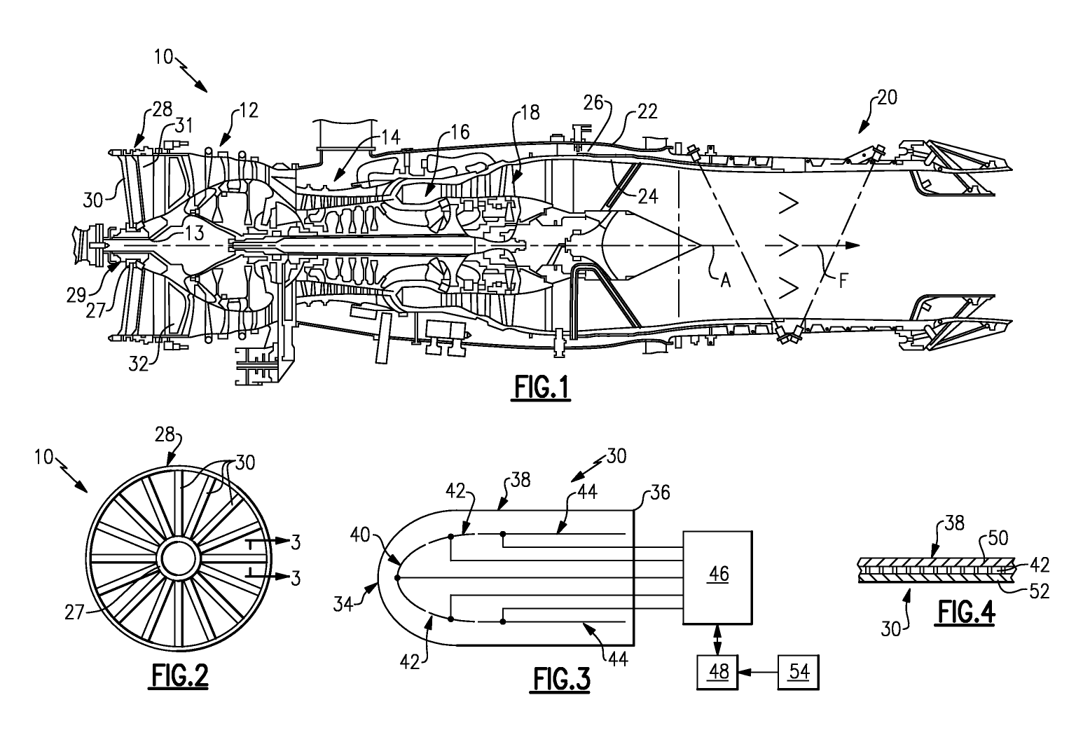

An example turbojet engine 10 is schematically shown in FIG. 1. The engine 10 includes a fan section 12 that is supported by a spool 13 rotatable about an axis A. A compressor section 14 is arranged downstream from the fan section 12 in a core engine. The core engine also includes a combustor 16 and a turbine section 18.

The engine 10 includes an afterburner 20 arranged downstream from the core engine that receives a flow F from the core. The engine 10 includes an inner wall 24 and an outer wall 22 that is arranged radially outwardly of the inner wall 24 to provide a bypass duct 26. The core engine is arranged inside the bypass duct 26. The fan section 12 provides compressed air to both the compressor section 14 and the bypass duct 26.

The example engine 10 includes an inlet case 28, shown in FIGS. 1 and 2. The inlet case 28 includes multiple inlet struts 30 extending radially and arranged circumferentially to support a central collar 27. The collar 27 carries a bearing 29 that rotationally supports the spool 13. In the example shown, variable inlet guide vanes 31 are arranged axially between the inlet struts 30 and a first stage 32 of the fan section 12.

The inlet struts 30 are typically subjected to the coldest temperatures of the engine 10 since they provide the entry way for airflow into the engine. As a result, ice may accumulate on the inlet struts 30. Referring to FIG. 3, the inlet struts 30 includes leading and trailing ends 34, 36 opposite one another. The leading end 34 faces airflow entering the engine 10, while the trailing end 36 is arranged downstream from the leading end 34. Spaced apart sidewalls 38 adjoin the leading and trailing ends 34, 36.

The example deicing system uses multiple heating elements to selectively deice portions of the inlet struts 30. In one example shown in FIG. 3, a first heating element 40 is arranged at the leading end 34 of the inlet struts 30. Second heating elements 42 are arranged in the sidewalls 38, or further downstream from the leading end 34. Third heating elements 44 are arranged further downstream from the second heating elements 42 in the sidewalls 38. The first, second and third heating elements 40, 42, 44 are in communication with a power source 46. A controller 48 is in communication with the power source 46 and a sensor 54, for example, that provides inlet temperature information associated with the inlet case 28. The power source 46 and controller 48 may be integrated with one another or separate components. The controller 48 may be hardware and/or software.

The controller 48 is configured to selectively energize the first, second and third heating elements 40, 42, 44 to deice the various portions of the inlet struts 30 in a manner sufficient to prevent ice from reaching a critical size on the inlet struts 30 while preventing a loss of engine power or efficiency when deicing of the struts 30 is not needed. The heating elements may provide different heat fluxes and/or deliver a different amount of energy per unit of time. In one example, the first heating element 40 may be continuously energized. The second heating element 42 may be cycled on and off more and more frequently than the third heating element 44 is cycled on and off. The size or coverage of the heating elements 40, 42 and 44 can be determined through icing analysis and component tests. Thermal analysis can also be used to determine the power necessary at each of the heating elements at varying inlet temperatures that is sufficient to clear the ice from the surface of the inlet struts 30. Thus, each heating element provides a different amount of heat flux per unit of time based upon the icing conditions experienced at the location of each respective heating element. This approach avoids wasting turbine engine power and efficiency.

The heating elements may be electrically actuated elements or foils, for example. The heating elements can be embedded in the structure of the inlet struts 30, which may be composite. For example, referring to FIG. 4, the second heating element 42 is embedded between first and second fiberglass or carbon fiber layers 50, 52. Thus, the heating elements are arranged beneath the outer surface of the inlet struts 30.

Although example embodiments have been disclosed, a worker of ordinary skill in this art would recognize that certain modifications would come within the scope of the claims. For that reason, the following claims should be studied to determine their true scope and content.

What is claimed is:

1. A gas turbine engine comprising:
an inlet case including circumferentially spaced, radially extending inlet struts that each have a leading and trailing end, spaced apart sidewalls adjoining the leading and trailing ends; and
a first heating element arranged on the leading end, and a second heating element different than the first heating element and arranged on at least one of the sidewalls.

2. The gas turbine engine according to claim 1, wherein the first heating element configured to provide a different amount of energy per unit of time than the second heating element

3. The gas turbine engine according to claim 2, comprising a controller in communication with the first and second heating elements, the controller configured to receive inlet temperature information and the controller configured to selectively cycle on and off the second heating element more than the first heating element based upon the inlet temperature information.

4. The gas turbine engine according to claim 2, comprising a third heating element, the second heating element arranged axially between the first and second heating elements, the third heating element including an energy per unit of time that is different than the energy per unit of time of the first and second heating elements.

5. The gas turbine engine according to claim 1, wherein the inlet case includes a collar having a bearing that supports a spool for rotation about an axis, a fan section supported on the spool and arranged downstream from the inlet struts.

6. The gas turbine engine according to claim 2, comprising variable inlet guide vanes arranged between a first stage of the fan section and the inlet struts.

7. The gas turbine engine according to claim 2, comprising a core engine arranged downstream from the fan section and a bypass duct surrounding the core engine and downstream from the fan section.

8. The gas turbine engine according to claim 1, wherein the inlet struts are composite structures and the heating elements are embedded in the composite structure.

9. A method of heating a gas turbine engine inlet component comprising the step of:
providing leading and trailing ends opposite one another, and spaced apart sidewalls adjoining the leading and trailing ends;
heating the leading end with a first heating element at a first time interval; and
heating one of the sidewalls with a second heating element at a second time interval that is different than the first time interval.

10. The method according to claim 9, comprising the step of electrically selectively energizing the first and second heating elements based upon inlet temperature information.

11. The method according to claim 9, wherein the providing step includes laminating the first and second heating elements between first and second layers.

12. The method according to claim 9, wherein the engine component is an inlet strut arranged upstream from a fan section.

13. A gas turbine engine inlet component comprising:
a common structure supporting first and second heating elements configured to provide a different amount of energy per unit of time than one another.

14. The gas turbine engine inlet component according to claim 13, wherein the first and second heating elements are laminated between first and second layers of an inlet strut.
